(19) United States
(12) Patent Application Publication
(10) Pub. No.: US 2011/0166989 A1
(43) Pub. Date: Jul. 7, 2011

(54) OFFSETTING LIABILITIES AND ATTRIBUTING REWARDS

(75) Inventors: Erik Stephen Ross, Charlotte, NC (US); Susan Smith Thomas, Gastonia, NC (US)

(73) Assignee: BANK OF AMERICA CORPORATION, Charlotte, NC (US)

(21) Appl. No.: 12/651,577

(22) Filed: Jan. 4, 2010

(51) Int. Cl. G06Q 40/00; G06Q 30/00; G06Q 10/00

(52) U.S. Cl. 705/39; 705/14.17; 705/30

(57) ABSTRACT

Embodiments of the present invention relate to methods and apparatuses for determining, recommending, and/or executing a payment strategy for offsetting liabilities and/or attributing rewards. For example, in some embodiments, a method is provided for transferring offsetting funds from a first account to a second account. In such embodiments, the method includes: (1) determining that the second account has incurred a liability; and (2) transferring funds from the first account to the second account in an amount sufficient to offset the liability. In some embodiments, the determining step automatically triggers the transferring step, either immediately, nearly immediately, or sometime after the occurrence of the determining step. In some embodiments, the method further includes attributing rewards to the first account or the second account based at least partially on the transfer of offsetting funds from the first account to the second account and/or based at least partially on the second account incurring the liability.

### FIELD

In general terms, embodiments of the present invention relate to methods and apparatuses for determining, recommending, and/or executing a payment strategy for offsetting liabilities and/or attributing rewards.

### BACKGROUND

Financial institution customers are constantly looking for new and useful ways to mitigate or eliminate the hassles associated with managing their finances, particularly those associated with making (and remembering to make) account payments. This is particularly so given that most of today's financial institution customers have multiple financial accounts and the consequences associated with improperly making and/or missing a payment on any one of them can include additional fees, added interest, lower credit scores, and/or other penalties. Accordingly, there is a need to provide methods and apparatuses that help financial institution customers better manage their finances, and in particular, help customers make (and remember to make) account payments.

### SUMMARY OF SELECTED EMBODIMENTS OF THE PRESENT INVENTION

Embodiments of the present invention relate to methods and apparatuses for determining, recommending, and/or executing a payment strategy for offsetting liabilities and/or attributing rewards. For example, in some embodiments, a method is provided for transferring offsetting funds from a first account to a second account. In such embodiments, the method includes: (1) determining that the second account has incurred a liability; and (2) transferring funds from the first account to the second account in an amount sufficient to offset the liability. Additionally, in some embodiments of the method, the determining step automatically triggers the transferring step.

In some embodiments, the method further includes attributing rewards to the first account or the second account based at least partially on the transferring step. In some embodiments, the method includes attributing rewards to the second account based at least partially on the second account incurring the liability. As another example, in some embodiments, the method includes determining that the first account includes funds sufficient to offset the liability.

In some embodiments of the method, the determining step further includes determining, at end of day, that the second account has incurred the liability. In some embodiments of the method, the first account includes a deposit account and the second account includes a credit account. In some embodiments, the first account is maintained by a first financial institution and the second account is maintained by a second financial institution. In some embodiments, the first account includes two or more accounts.

In some embodiments of the method, the transferring step occurs immediately or nearly immediately after the determining step. In some embodiments of the method, the second account incurring the liability automatically triggers the determining step. In other embodiments, the determining step also occurs immediately or nearly immediately after the second account incurs the liability. In some embodiments of the method, the transferring step and the determining step are both implemented on the same day. In some embodiments, a user-selected triggering event automatically triggers the determining step. As an example, in some embodiments, the user-selected triggering event includes a user-selected time. In some embodiments of the method, the liability includes an amount greater than or equal to a user-selected target amount.

In some embodiments, the method further includes: (1) determining a trend based at least partially on a transaction history of the first account or a transaction history of the second account; and (2) determining a triggering event based at least partially on the trend, such that the offsetting funds transfer occurs immediately or nearly immediately after an occurrence of the triggering event. In some embodiments, the method further includes communicating a triggering event recommendation to a user, where the triggering event recommendation includes information associated with the triggering event, and where the triggering event recommendation includes functionality configured to enable the user to accept, modify, or reject one or more portions of the triggering event recommendation. In some embodiments, the method includes determining a triggering event based at least partially on a user-predicted future behavior, such that the offsetting funds transfer occurs immediately or nearly immediately after an occurrence of the triggering event.

As another example, in some embodiments of the present invention, a system is provided for transferring offsetting funds from a first account to a second account. In such embodiments, the system includes a processor configured to: (1) determine that the second account has incurred a liability; and (2) transfer funds from the first account to the second account in an amount sufficient to offset the liability. Additionally, in some embodiments of the system, the processor determining that the second account has incurred the liability automatically triggers the processor to transfer the funds from the first account to the second account.

As still another example, in some embodiments of the present invention, a computer program product is provided for transferring funds from a first account to a second account. In such embodiments, the computer program product includes a computer-readable medium having computer-executable program code portions stored therein. In some embodiments, the computer-executable program code portions include: (1) a first program code portion configured to determine that a second account has incurred a liability; and (2) a second program code portion configured to transfer funds from the first account to the second account in an amount sufficient to offset the liability. In some embodiments of the computer program product, execution of the first program code portion automatically triggers execution of the second program code portion.

As a further example, in some embodiments of the present invention, a system is provided for transferring offsetting funds from a first account to a second account. In such embodiments, the system includes a processor that is configured to: (1) determine that the second account has incurred a liability; (2) determine a trend based at least partially on a transaction history of the first account or a transaction history of the second account; (3) determine a triggering event based at least partially on the trend; and (4) transfer funds from the first account to the second account in an amount sufficient to offset the liability. In some embodiments of the system, an occurrence of the triggering event automatically triggers the processor to transfer the funds from the first account to the second account.

### BRIEF DESCRIPTION OF THE DRAWINGS

Having thus described embodiments of the present invention in general terms, reference will now be made to the accompanying drawings, wherein:

FIG. 1 is a flow diagram illustrating a general process flow of a system for executing a payment strategy for offsetting liabilities and attributing rewards, in accordance with an embodiment of the present invention;

FIG. 2 is a block diagram illustrating technical components of a system for determining, recommending, and/or executing a payment strategy for offsetting liabilities and/or attributing rewards, in accordance with an embodiment of the present invention;

FIG. 3 is a mixed block and flow diagram of a system for executing a payment strategy for offsetting liabilities and attributing rewards, in accordance with an embodiment of the present invention;

FIG. 4 is a flow diagram illustrating a general process flow of a system for determining and executing a payment strategy for offsetting liabilities based at least partially on one or more user-selected times, in accordance with an embodiment of the present invention;

FIG. 5 is a flow diagram illustrating a general process flow of a system for determining and executing a payment strategy for offsetting liabilities based at least partially on one or more user-selected target amounts, in accordance with an embodiment of the present invention; and

FIG. 6 is a flow diagram illustrating a general process flow of a system for determining and executing a payment strategy for offsetting liabilities based at least partially on a trend and for attributing rewards, in accordance with an embodiment of the present invention.

### DETAILED DESCRIPTION OF EMBODIMENTS OF THE PRESENT INVENTION

Embodiments of the present invention will now be described more fully hereinafter with reference to the accompanying drawings, in which some, but not all, embodiments of the present invention are shown. Indeed, the present invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and/or vice versa, unless explicitly stated otherwise. Also, as used herein, the term “a” and/or “an” shall mean “one or more,” even though the phrase “one or more” is also used herein. Like numbers refer to like elements throughout.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, an electronic, magnetic, optical, electromagnetic, infrared, and/or semiconductor system, apparatus, and/or device. For example, in some embodiments, the computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a computer-readable medium (e.g., a memory) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator- and/or human-implemented steps in order to carry out an embodiment of the present invention.

Further, although many of the embodiments of the present invention described herein are generally described as involving a “financial institution,” other embodiments of the present invention may involve one or more persons, organizations, businesses, and/or other entities that take the place of, or work in conjunction with, the financial institution to implement one or more of the embodiments described and/or contemplated herein as being performed by the financial institution.

In general terms, embodiments of the present invention relate to methods and apparatuses for determining, recommending, and/or executing a payment strategy for offsetting liabilities and/or attributing rewards. To illustrate a specific example, when a financial institution customer incurs a liability by using a rewards credit card account to make one or more purchases, an embodiment of the present invention is automatically triggered to immediately or nearly immediately transfer funds from the customer's checking account to the customer's rewards credit card account in an amount sufficient to offset the liability. As such, the customer may accomplish several goals: (1) accumulate rewards by using the rewards credit card; (2) eliminate the hassles associated with making (and remembering to make) monthly credit card payments; and (3) maintain a zero average daily balance on the rewards credit card account at all times, which helps the consumer avoid fees, late payments, lower credit scores, and/or the other negative effects associated with carrying a non-zero credit card balance. Of course, it will be understood that this specific example is presented by way of illustration and is not meant to capture the entire scope and spirit of the present invention—indeed, as described in more detail herein, other embodiments of the present invention may be different.

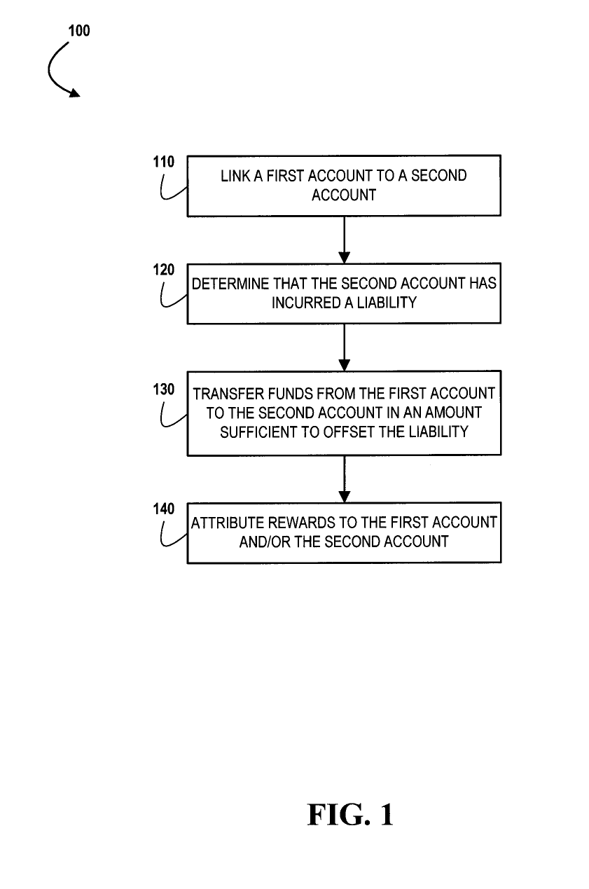

Referring now to FIG. 1, a general process flow 100 of a system for executing a payment strategy for offsetting liabilities and attributing rewards is presented, in accordance with an embodiment of the present invention. As represented by the block 110, the system is configured to link (and/or facilitate a user to link) a first account to a second account. As represented by the block 120, the system is also configured to determine that the second account has incurred a liability. As represented by the block 130, the system is then configured to transfer funds from the first account to the second account in an amount sufficient to offset the liability. As represented by the block 140, the system is further configured to attribute rewards to the first account and/or to the second account.

Regarding the step represented by the block 110, it will be understood that the system may link the first account to the second account in any way, and that, by “linked,” it is meant that the first account is electronically and/or communicably connected to the second account, such that, for example, funds in the first account may be transferred to the second account and/or vice versa. It will also be understood that the first account and the second account may be determined and/or selected in any way. For example, in some embodiments, the system is configured to prompt and/or enable a user (e.g., the first and/or second account holder, a financial institution employee, etc.) to determine, identify, input, define, and/or otherwise select (collectively referred to herein as “select” for simplicity) the first account and the second account for linking As another example, in some embodiments, the system having the process flow 100 is configured to determine, and/or recommend to a user, the first account and the second account for linking For example, in some embodiments, the system is configured to access a bank customer's online and/or mobile banking account to determine the number and types of accounts held by the customer, how frequently those accounts are used (e.g., via the transaction history of those accounts), how well those accounts are funded, etc., and then based on that information, recommend to the customer which accounts he or she should select for linking.

It will be understood that the first account and the second account may be and/or include any type of account. For most embodiments, the first account is a deposit account (e.g., checking account, savings account, money market account, certificate of deposit account, investment account, etc.), and the second account is a revolving credit account (e.g., a credit card account, a line of credit (LOC) account, a home equity line of credit (HELOC) account, etc.). However, it will be understood that, in some embodiments, the second account is an installment credit account, such as, for example, a student loan account, a home equity loan account, a car loan account, a mortgage account, and/or the like. Alternatively, in some embodiments, the second account is a non-traditional financial account, such as, for example, a grocery store account (e.g., for purchasing groceries with store-extended credit, for receiving and/or paying grocery store invoices, etc.), an online account with a cable company (e.g., for receiving and paying cable bills), and/or the like. It will also be understood that, in some embodiments, the first account and the second account are both credit accounts, such as, for example, where the first account and the second account are both credit card accounts, where the first account is a HELOC account and the second account is a credit card account, and/or the like.

Further, it will be understood that, in some embodiments, the first account, the second account, and/or the system are owned, controlled, serviced, managed, operated, and/or maintained (collectively referred to herein as “maintained” for simplicity) by a single financial institution. For example, in some embodiments, the system is maintained by a bank, the first account is maintained by the bank and held by a bank customer, the second account is maintained by the bank and held by the same bank customer, and the system is configured to link the bank customer's first account to the bank customer's second account. Of course, in accordance with some embodiments, the first account and the second account need not be maintained by the same financial institution (or any financial institution). For example, in some embodiments, the system having the process flow 100 is configured to execute a payment strategy involving a checking account maintained by Financial Institution A and a credit card account maintained by Financial Institution B.

Also, it will be understood that, although much of the description herein refers to accounts held by individuals, the first account and/or the second account may be held by one or more families, households, social networks, businesses (e.g., corporations, business units within corporations, small businesses, for profit, non-profit, etc.), and/or other entities. For example, in some embodiments, the system having the process flow 100 is configured to execute a payment strategy that involves a family checking account (e.g., the first account) and a family credit card account (e.g., the second account), where each account is jointly held by husband and wife. As another example, in some embodiments, the system is configured to execute a payment strategy that involves a small business checking account and a small business LOC account. Of course, it will be understood that some embodiments of the present invention may involve at least two different types of entities, such as, for example, where the first account is an individual's checking account and the second account is a family credit card account.

Regarding the step represented by the block 120, it will be understood that the term “liability,” as used herein, typically refers to one or more debt obligations associated with an account. For example, in some embodiments where the second account is a credit card account, a liability typically refers to the amount of one or more individual credit card transactions involving the credit card account. As another example, in some embodiments where the second account is a HELOC account, a liability typically refers to the amount of one or more individual draws of credit on the HELOC account. As still another example, in some embodiments where the second account is an account with a cable company, the liability typically refers to a periodic (e.g., monthly) charge in a cable bill. Still further, in some embodiments where the second account is a car loan account, the liability typically refers to a periodic (e.g., monthly) car loan payment due. It will be understood that a liability may refer to all or part of the balance of the account.

It will also be understood that the system can be configured to make liability determinations in any way. For example, in some embodiments, the system having the process flow 100 may be embodied as, or in, a financial transaction processing system that is configured to process financial transactions involving the first and/or second accounts. In such embodiments, the system having the process flow 100 may be configured to make liability determinations for the second account at the same time (or nearly the same time) as transactions involving the second account are processed. As another example, in other embodiments, the system having the process flow 100 is configured to access the second account and analyze the transaction history associated with the second account in order to identify one or more incurred liabilities. (Examples of transaction history information include, but are not limited to, information normally found in an account statement, such as, for example, purchase amounts, descriptions of goods/services purchased, transaction dates, monthly charges, merchant names, etc.) As still another example, in some embodiments, the system having the process flow 100 may be configured to receive one or more notifications (from, e.g., a financial transaction processing system) that the second account has incurred one or more liabilities.

It will also be understood that the system may be configured to make liability determinations in real time, in substantially real time, and/or at one or more predetermined times. For example, in some embodiments, the system is configured to make liability determinations continuously, such that the system can identify a liability immediately or nearly immediately after the liability is incurred (e.g., upon the swipe of a credit card, upon the release of an account statement, etc.). As another example, in some embodiments, the system is configured to make liability determinations at a specific time during the day, such as, for example, at the end of day, at mid day, at the beginning of day, at 12:45 pm, etc. In other embodiments, the system may be configured to make liability determinations at the end of every week, at the end of the month, just after an account statement is ready, just before a payment due date, and/or at one or more other predetermined times.

Regarding the step represented by the block 130, by “offset,” it is meant that the total amount of funds transferred from the first account to the second account at least equals the total amount of the liability incurred by the second account. For example, in some embodiments, where the amount of the liability incurred is $200, the system having the process flow 100 is configured to transfer exactly $200 from the first account to the second account. However, in some embodiments, where the amount of the liability incurred is $200, the system having the process flow 100 is configured to transfer more than $200 from the first account to the second account. Thus, it will be understood that the system having the process flow 100 is configured to transfer funds in an amount equal to or greater than the amount of the liability.

Those having ordinary skill in the art will understand that making an offsetting funds transfer is sometimes referred to as “sweeping” one or more liabilities from an account. In addition, making an offsetting funds transfer is sometimes referred to as “paying off” one or more liabilities incurred by an account. For simplicity, it will be understood that, as used herein, the meaning of the term “offsetting” also includes the meanings of the terms “sweeping” and “paying off,” unless explicitly stated otherwise.

It will also be understood that some embodiments of the present invention are configured to offset each and every liability from the account in order to maintain a zero account balance for that account at all times. However, it will also be understood that, in some embodiments, the system is configured to offset one or more liabilities in order to maintain a predetermined, non-zero account balance for that account. For example, in some embodiments where the second account is a credit card account, the system having the process flow 100 can be configured to offset any liability from the credit card account that would increase the average daily account balance above $500 (or some other predetermined amount).

It will also be understood that the system can be configured to make offsetting funds transfers in any way. For example, in some embodiments, the system is configured to electronically wire offsetting funds from the first account to the second account. It will also be understood that the system may be configured to transfer offsetting funds at one or more predetermined times. For example, in some embodiments, the system may be configured to automatically transfer offsetting funds just prior to the payment due date for the second account. As other examples, the system may be configured to transfer offsetting funds at the end of every week (if needed), at the end of the day in which the liability was incurred, at the end of the day in which the system determined the liability (which may or may not be the same day on which the liability was incurred), and/or at one or more other predetermined times.

In some embodiments, the system is additionally or alternatively configured to transfer offsetting funds (and/or implement any of the other steps represented by the blocks 110-140) upon or after one or more triggering events. As used herein, it will be understood that a “triggering event” refers to an event that automatically triggers the execution, performance, and/or implementation of a triggered action, either immediately, nearly immediately, or sometime after (e.g., within the same day or week or month, at a predetermined time, etc.) the occurrence of the event. For example, in some embodiments, the system having the process flow 100 is configured such that the system making a liability determination (the triggering event) automatically triggers the system to transfer the offsetting funds (the triggered action). In some cases, the system may be configured to automatically transfer the offsetting funds immediately or nearly immediately after making the liability determination. However, in other embodiments, instead of immediately or nearly immediately after making the liability determination, the system is configured to automatically transfer the offsetting funds at some predetermined time after making the liability determination (e.g., forty-eight hours after making the liability determination, at the end of day on the Friday after making the liability determination, etc.).

It will be understood that a triggering event for implementing any of the steps represented by the blocks 110-140 can be any user-selected, system-determined, and/or otherwise predetermined event. The occurrence of the triggering event may be expected (e.g., making an offsetting funds transfer upon or after a regular, bimonthly paycheck is deposited into the first account, etc.) or unexpected (e.g., making an offsetting funds transfer upon or after an unexpected deposit (e.g., unexpected gift, inheritance, etc.) is made into the first account, etc.). It will also be understood that, in addition to, or instead of, making a deposit into the first account, any other type and/or amount of inflow into and/or outflow out of the first account and/or the second account may serve as a triggering event. As another example, in some embodiments, the event of the second account incurring the liability serves as a triggering event for, for example, making a liability determination and/or an offsetting funds transfer. As still another example, in some embodiments, the triggering event is based at least partially on an account statement, such that, for example, the system is configured to automatically make an offsetting funds transfer (and/or implement any of the other steps represented by the blocks 110-140) upon or after the creation, publication, and/or transmission of an account statement for the first and/or second account.

As another example of a triggering event, in some embodiments, the system is configured to automatically make an offsetting funds transfer (and/or implement any of the other steps represented by the blocks 110-140) based at least partially on the user's (e.g., first and/or second account holder's) current and/or previous geographic location as determined by, for example, a mobile device (e.g., mobile phone, pager, personal digital assistant, personal computer, etc.) carried by the user. For example, in some embodiments, the system having the process flow 100 is configured to make an offsetting funds transfer upon or after determining that the account holder is at home, at work, near a particular store, within a certain zip code, and/or otherwise positioned relative to one or more predetermined geographic locations.

As still another example, in some embodiments, the triggering event for implementing one or more of the steps represented by the blocks 110-140 is and/or includes a predetermined time and/or the passage of a predetermined period of time. Examples of temporal triggering events include, but are not limited to, the end of day on a particular day, the beginning of day on the first and fifteenth of every month, 12:00 pm on the payment due date, 3:00 pm every Tuesday, 11:59 pm on the Monday before the end of the month, after every ten day period, two weeks after the previous payment, two days before a student loan payment is scheduled to be paid using funds from the first account, etc. It will be understood that, in some embodiments, triggering events are scheduled as one-time only events (e.g., at 2:57 pm on Dec. 27, 2009, etc.), but that in other embodiments, triggering events are recurring such that they occur periodically (e.g., after every deposit, every other Monday, at the first of every month, etc.). It will also be understood that the system having the process flow 100 can be configured to determine any number of triggering events, as well as make any number of offsetting funds transfers, such that, in some embodiments, the system is configured to execute a payment strategy that involves making an offsetting funds transfer as often as every day (or even more frequently).

Also regarding the step represented by the block 130, it will be understood that, in some embodiments, the “first account” and/or the “second account” includes two or more accounts. In other words, in some embodiments, the system having the process flow 100 is configured to execute a payment strategy that involves more than two accounts. For example, in some embodiments, the system is configured to execute a payment strategy that involves a checking account, a savings account, and a credit card account, such that at least some funds from the checking account and at least some funds from the savings account are used to offset one or more liabilities incurred by the credit card account. As another example, in some embodiments, the system having the process flow 100 is configured to execute a payment strategy that involves a savings account, a credit card account, a mortgage account, and a student loan account, such that funds from the savings account are used to offset one or more liabilities incurred by the credit card account, one or more liabilities incurred by the mortgage account, and one or more liabilities incurred by the student loan account.

Of course, it will be understood that, where a payment strategy involves more than two accounts, the offsetting funds transfers may be made in any way. For example, the system having the process flow 100 may execute a payment strategy that uses funds from a checking account to fund, for example, 30% of every offsetting funds transfer and funds from a savings account to fund 70% of every offsetting funds transfer. As another example, the payment strategy may involve using funds from a checking account to fund the entire first offsetting funds transfer and funds from a savings account to fund every offsetting funds transfer thereafter. As still another example, in some embodiments, the system is configured to execute a payment strategy where only funds from a first checking account are used to offset liabilities incurred by a first credit card account, and where only funds from a second checking account are used to offset liabilities incurred by a second credit card account. In some embodiments, the system having the process flow 100 is configured to determine (and/or prompt a user to select) which of the multiple accounts to use when making an offsetting funds transfer. Specifically, in some embodiments, the system may determine and/or the user may select a particular order, sequence, and/or priority of accounts to use in making offsetting funds transfers, such as, for example, first use a checking account to make offsetting funds transfers, and when the checking account is nearly depleted and/or otherwise reaches a predetermined threshold, use a savings account to make offsetting funds transfers, and so on. In some embodiments, the way in which offsetting funds transfers are made may be based at least partially on one or more rules, trends, user-predicted future behaviors, system determinations, user selections, and/or the like, some of which are described in more detail later herein.

Regarding the step represented by the block 140, the term “rewards,” as used herein, typically refers to one or more benefits associated with an account, such as, for example, rewards points, rewards multipliers (2×, 3×, etc.), airline miles, cash back, a one-time statement credit, a lower interest rate, a fee refund, an interest payment rebate, and/or the like. It will be understood that the system can be configured to attribute rewards to the first account and/or the second account for any reason. In some embodiments, the system is configured to attribute rewards based at least partially on using and/or having the first account and/or the second account. For example, in some embodiments, the second account is a rewards credit card account that is structured to accumulate rewards when the rewards credit card account is used to make purchases. In other words, in some embodiments, the rewards are based at least partially on the second account incurring one or more liabilities.

As still another example, in some embodiments, the system is configured to attribute rewards to the first account and/or the second account based at least partially on making an offsetting funds transfer. Specifically, in some embodiments, the system is configured to attribute rewards to the first account every time funds from the first account are used to offset a liability incurred by the second account. In still other embodiments, the system is configured to attribute rewards to a third account as a result of linking the first account to the second account and/or making one or more offsetting funds transfers from the first account to the second account. For example, in some embodiments, every time offsetting funds are transferred from a bank customer's checking account to the bank customer's LOC account, the system is configured to deposit cash (e.g., matching funds) into the bank customer's savings account.

As another example, in some embodiments, the system is configured to attribute rewards to the first account and/or the second account based at least partially on linking the first account to the second account. As still another example, in some embodiments, the system is configured to attribute rewards to the first account and/or the second account for enrolling the first account, the second account, and/or the account holder in a financial institution program and/or service for offsetting liabilities. It will be understood that the way in which rewards are attributed may be based at least partially on one or more rules, trends, user-predicted future behaviors, system determinations, user selections, and/or the like, some of which are described in more detail later herein.

It will be understood that one or more of the steps represented by the blocks 110-140 may serve as a triggering event for one or more of the other steps represented by the blocks 110-140. For example, as already mentioned, the system may be configured to automatically transfer the offsetting funds immediately, nearly immediately, or sometime after determining that the second account has incurred the liability. As another example, in some embodiments, the system is automatically configured to attribute rewards to the first account and/or to the second account upon or after transferring the offsetting funds. Of course, as previously mentioned, in some embodiments, a predetermined time and/or the passage of a predetermined period of time may serve to trigger one or more of the steps represented by the blocks 110-140. For example, in some embodiments, the system having the process flow 100 is configured to automatically transfer offsetting funds from the first account to the second account three days after determining that the second account has incurred a liability.

In some embodiments, one or more steps other than those represented by the blocks 110-140 may serve as a triggering event for one or more of the steps represented by the blocks 110-140, and/or vice versa. For example, in some embodiments, the system having the process flow 100 is configured to automatically determine that the second account has incurred a liability immediately, nearly immediately, or sometime after the second account actually incurs the liability. Thus, it will be understood that the system can be configured to determine, in real time or substantially real time, whether the second account has incurred a liability. In other embodiments, the system may be additionally or alternatively configured to transfer offsetting funds and/or attribute rewards in real time or near real time as well.

Further, it will be understood that the number, order, and/or content of the steps represented by the blocks 110-140 are exemplary and may vary. For example, in some embodiments, the system is configured to omit the rewards attribution step represented by the block 140. As still another example, in some embodiments, the system is configured to attribute rewards to the first account and/or the second account after determining that the second account has incurred a liability but before transferring the offsetting funds.

As a further example of an additional or alternative step, in some embodiments, the system having the process flow 100 is configured to determine whether the first account has sufficient funds before making an offsetting funds transfer from the first account to the second account. It will be understood that these sufficiency determinations can be made in any way, such as, for example, by analyzing the transaction history of the first account. It will also be understood that, in accordance with some embodiments, if the first account does not have sufficient funds to make the offsetting funds transfer, then the system may be configured to stop, queue, and/or otherwise prevent the offsetting funds transfer from being made in order to prevent an overdraft of the first account.

Alternatively, in embodiments where one or more additional accounts having sufficient funds are linked to the second account, the system may be configured to transfer offsetting funds from those one or more other accounts instead from the insufficient first account. In such embodiments, the system may be configured to follow a particular order or sequence when determining which accounts to use in offsetting the liability of the second account. For example, in some embodiments, the system is configured to offset the liability using the account with the highest account balance. As another example, in some embodiments, the system is configured to use a preferred account to offset the liability unless and/or until that preferred account does not have sufficient funds to make the offsetting funds transfer.

As still another example, in some alternate embodiments, the system having the process flow 100 is configured to aggregate multiple individual liabilities before making offsetting funds transfers. For example, a consumer may use a credit card account to purchase a $10 breakfast sandwich on Tuesday morning, to pay a $100 student loan payment on Tuesday afternoon, and then to purchase a $50 ticket to a football game on Tuesday evening. In such a case, the system may be configured to aggregate those individual credit card liabilities and then transfer funds from the consumer's checking account to the consumer's credit card account in an amount sufficient to offset those liabilities. In other words, some embodiments of the system are configured to make a one-time offsetting funds transfer of $160 at some later time on Tuesday instead of making three smaller offsetting funds transfers during the day on Tuesday (as other embodiments of the system are configured to do).

It will be understood that, in some embodiments, the system having the process flow 100 is also configured to implement, communicate with, and/or be otherwise associated with online and/or mobile banking services. For example, in some embodiments, the system having the process flow 100 is also configured to deliver online and/or mobile banking services to one or more online banking customers via one or more online banking accounts. As another example, in some embodiments, one or more portions of an online and/or mobile banking account (e.g., an online banking tool) are configured to configure and/or trigger the system having the process flow 100 to perform the steps of the process flow 100. In some embodiments, one or more portions of an online and/or mobile banking account are additionally or alternatively configured to configure (and/or facilitate an online banking customer to configure) the system having the process flow 100 and/or the steps of the process flow 100. For example, in some embodiments, an online banking customer may access an online banking tool via an online banking account in order to select which accounts to link, schedule when liability determinations and/or offsetting funds transfers are made, determine how and/or when rewards are attributed, and so on. In some embodiments, the online and/or mobile banking account may additionally or alternatively be configured to receive one or more notifications associated with one or more of the steps of the process flow 100 (e.g., an e-mail message created/sent by the system that confirms that two accounts have been linked, a digital receipt created/sent by the system that has information associated with the offsetting funds transfer, etc.).

It will also be understood that, in some embodiments, the system having the process flow 100 is additionally or alternatively configured to monitor (and/or facilitate a user to monitor) the financial health of the first account, the second account, and/or the account holder. For example, a bank may maintain the system having the process flow 100, and a bank customer may be the holder of the first account and the second account. In such a case, the system could be configured to automatically notify the bank and/or the bank customer when the customer's first account has insufficient funds to offset a liability from the second account, when the customer's second account incurs a liability above a predetermined amount, and/or when some other indicator of financial distress occurs.

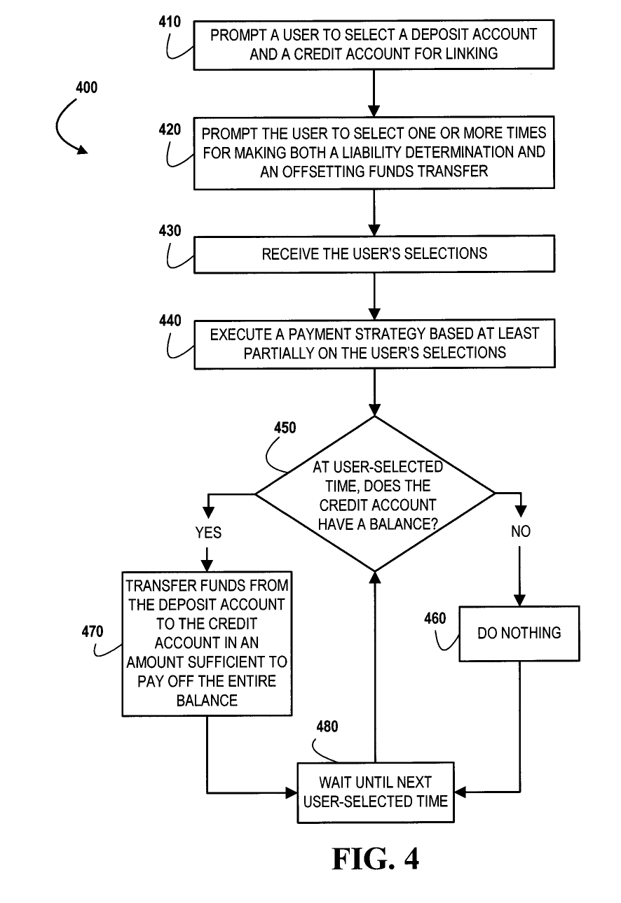

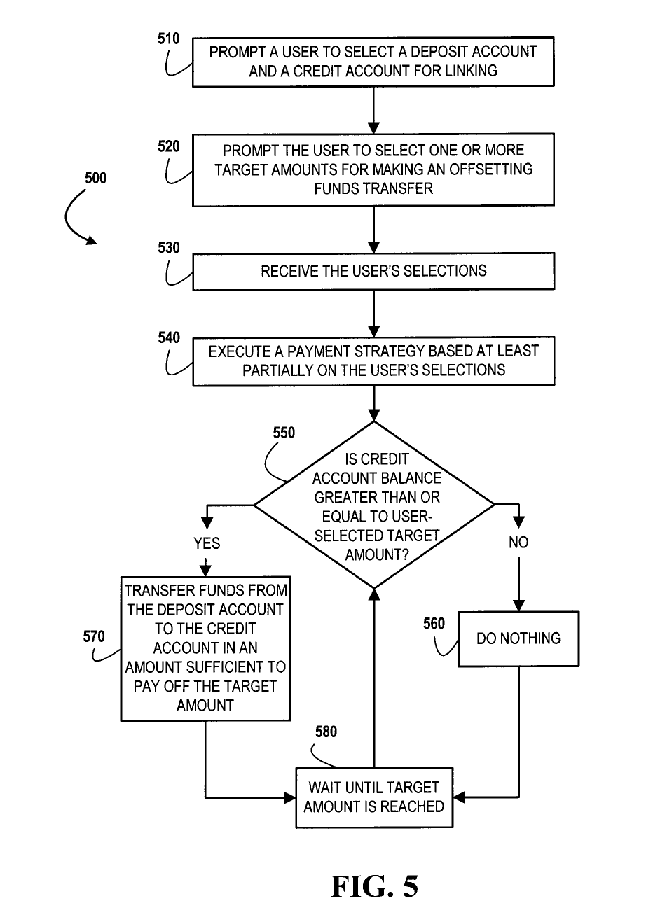

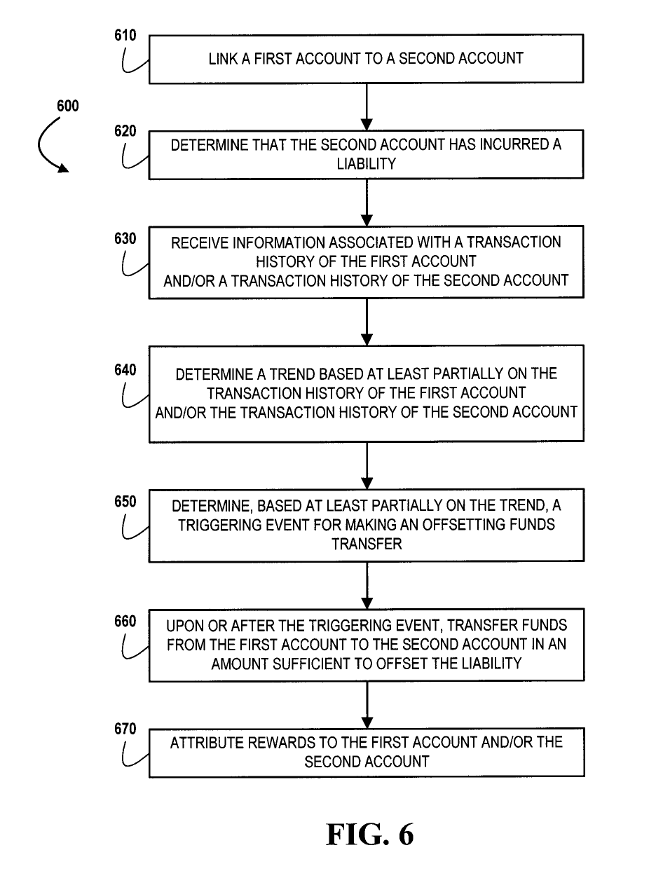

Of course, it will also be understood that the system having the process flow 100 can be configured to implement any combination of any one or more of the steps, and/or portions of steps, from any one or more of the process flows described and/or contemplated herein. For example, in some embodiments, the system is configured to provide a triggering event recommendation to a user of the system, as described in more detail herein in connection with FIG. 6. As another example, in some embodiments, the system is configured to determine and/or follow one or more rules for governing the payment strategy, as discussed in more detail herein in connection with FIGS. 4 and 5.

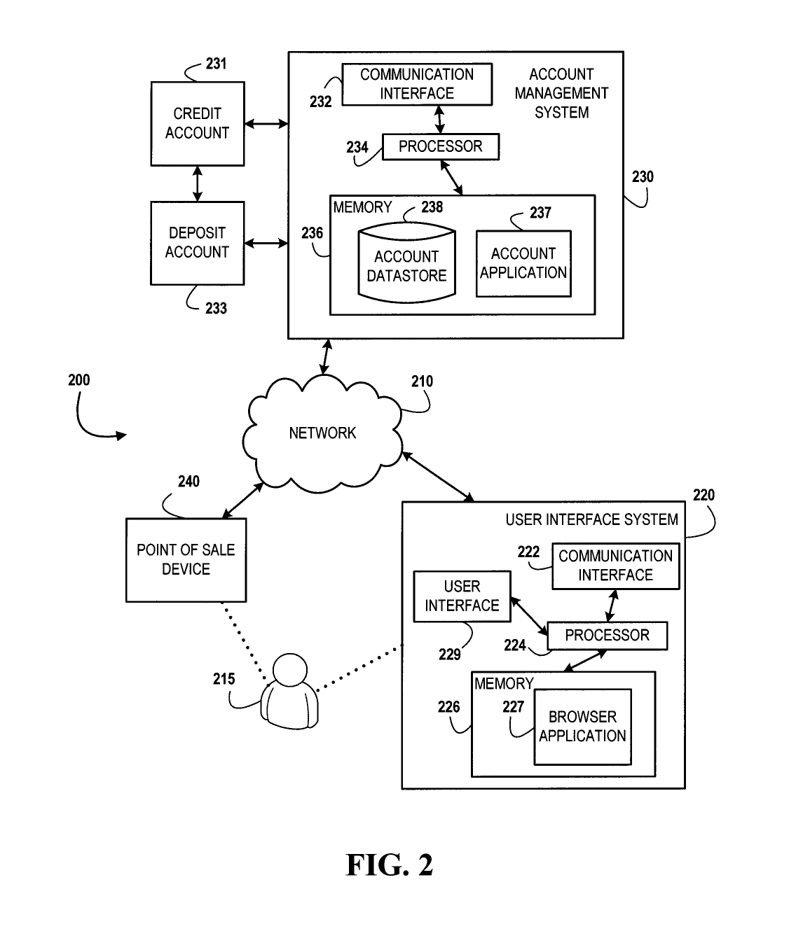

Referring now to FIG. 2, a system 200 for determining, recommending, and/or executing a payment strategy for offsetting liabilities and/or attributing rewards is provided, in accordance with an embodiment of the present invention. As illustrated, the system 200 includes a network 210, a user interface system 220, an account management system 230, and a point of sale device 240. FIG. 2 also illustrates a credit account 231 (e.g., a credit card account, a HELOC account, etc.) and a deposit account 233 (e.g., a checking account, a savings accounts, etc.), both of which are operatively connected (e.g., linked) to the account management system 230, as well as to each other. Also shown in FIG. 2 is a consumer 215 that has access to the user interface system 220 and the point of sale device 240. In this embodiment, the user interface system 220 is maintained by the consumer 215, the point of sale device 240 is maintained by a merchant (not shown), and the account management system 230, along with the credit account 231 and the deposit account 233, are maintained by a single financial institution (not shown) for the benefit of the consumer 215. It will also be understood that the consumer 215 may use the credit account 231 and/or the deposit account 233 to make one or more purchases from the merchant by using the point of sale device 240.

As shown in FIG. 2, the user interface system 220, the account management system 230, and the point of sale device 240 are each operatively and selectively connected to the network 210, which may include one or more separate networks. In addition, the network 210 may include a local area network (LAN), a wide area network (WAN), and/or a global area network (GAN), such as the Internet. It will also be understood that the network 210 may be secure and/or unsecure and may also include wireless and/or wireline technology.

The user interface system 220 may include any computerized apparatus that can be configured to perform any one or more of the functions of the user interface system 220 described and/or contemplated herein. In some embodiments, for example, the user interface system 220 may include a personal computer system, a mobile phone, a personal digital assistant, a public kiosk, a network device, and/or the like. As illustrated in FIG. 2, in accordance with some embodiments of the present invention, the user interface system 220 includes a communication interface 222, a processor 224, a memory 226 having a browser application 227 stored therein, and a user interface 229. In such embodiments, the communication interface 222 is operatively and selectively connected to the processor 224, which is operatively and selectively connected to the user interface 229 and the memory 226.

Each communication interface described herein, including the communication interface 222, generally includes hardware, and, in some instances, software, that enables a portion of the system 200, such as the user interface system 220, to transport, send, receive, and/or otherwise communicate information to and/or from the communication interface of one or more other portions of the system 200. For example, the communication interface 222 of the user interface system 220 may include a modem, server, electrical connection, and/or other electronic device that operatively connects the user interface system 220 to another electronic device, such as the electronic devices that make up the account management system 230.

Each processor described herein, including the processor 224, generally includes circuitry for implementing the audio, visual, and/or logic functions of that portion of the system 200. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the browser application 227 of the memory 226 of the user interface system 220.

Each memory device described herein, including the memory 226 for storing the browser application 227 and other data, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 2, the memory 226 includes the browser application 227. In some embodiments, the browser application 227 includes a web browser and/or some other application for communicating with, navigating, controlling, configuring, and/or using the account management system 230 and/or other portions of the system 200. For example, in some embodiments, the consumer 215 uses the browser application 227 to trigger and/or configure one or more aspects of the account management system 230 that relate to offsetting liabilities and/or attributing rewards. For example, in some embodiments, the consumer 215 uses the browser application 227 to select one or more times for making one or more liability determinations and/or one or more offsetting funds transfers (discussed in more detail herein in connection with FIG. 4). As another example, in some embodiments, the consumer 215 uses the browser application 227 to select one or more target amounts for making one or more liability determinations and/or one or more offsetting funds transfers (discussed in more detail herein in connection with FIG. 5). As still another example, in some embodiments the consumer 215 uses the browser application 227 to select one or more rules for governing a payment strategy and/or to predict one or more future behaviors (discussed in more detail herein in connection with FIGS. 4-6.) In some embodiments, the consumer 215 uses the browser application 227 to access an online and/or mobile banking account (not shown) for configuring these one or more aspects of the account management system 230. In some embodiments, the browser application 227 includes computer-executable program code portions for instructing the processor 224 to perform one or more of the functions of the browser application 227 described and/or contemplated herein. In some embodiments, the browser application 227 may include and/or use one or more network and/or system communication protocols.

Also shown in FIG. 2 is the user interface 229. In some embodiments, the user interface 229 includes one or more user output devices, such as a display and/or speaker, for presenting information to the consumer 215 and/or some other user. In some embodiments, the user interface 229 includes one or more user input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the consumer 215 and/or some other user. In some embodiments, the user interface 229 includes the input and display devices of a personal computer, such as a keyboard and monitor, that are operable to receive and display information associated with offsetting a liability and/or accumulating rewards.

FIG. 2 also illustrates an account management system 230, in accordance with an embodiment of the present invention. The account management system 230 may include any computerized apparatus that can be configured to perform any one or more of the functions of the account management system 230 described and/or contemplated herein. In accordance with some embodiments, for example, the account management system 230 may include a computer network, an engine, a platform, a server, a database system, a front end system, a back end system, a personal computer system, and/or the like. In some embodiments, such as the one illustrated in FIG. 2, the account management system 230 includes a communication interface 232, a processor 234, and a memory 236, which includes an account application 237 and an account datastore 238 stored therein. As shown, the communication interface 232 is operatively and selectively connected to the processor 234, which is operatively and selectively connected to the memory 236.

It will be understood that the account application 237 can be configured to implement any one or more portions of any one or more of the process flows described and/or contemplated herein. For example, in some embodiments, the account application 237 is configured to link the deposit account 233 to the credit account 231. As another example, in some embodiments, the account application 237 is configured to analyze the transaction history of the credit account 231 for purposes of determining when and/or if the credit account 231 has incurred a liability. As still another example, in some embodiments, the account application 237 is configured to transfer funds from the deposit account 233 to the credit account 231 in an amount sufficient to offset a liability incurred by the credit account 231. As a further example, in some embodiments, the account application 237 is configured to attribute rewards to the credit account 231 and/or the deposit account 233 (and/or some other account not shown) for using those accounts to make purchases and/or for making offsetting funds transfers.

It will also be understood that, in some embodiments, the account application 237 is additionally configured to provide other kinds of financial services. For example, in some embodiments, the account application 237 may be operable to process financial transactions involving the credit account 231 and/or the deposit account 233. In some cases, this function is performed alongside one or more of the steps described and/or contemplated herein that relate to making liability determinations, transferring offsetting funds, and/or attributing rewards. For example, where the consumer 215 attempts to make a purchase with the credit account 231 at the point of sale device 240, the account application 237 may be configured to approve a payment request from the point of sale device 240, as well as simultaneously (or sometime thereafter) determine that the credit account 231 has incurred a liability and transfer offsetting funds from the deposit account 233 to the credit account 231. As another example, in some embodiments, the account application 237 is configured to provide online and/or mobile banking services to the consumer 215 at the user interface system 220, such as, for example, any of the online and/or mobile banking services described and/or contemplated herein.

It will also be understood that, in some embodiments, the account application 237 is configured to communicate with the account datastore 238, the user interface system 220, the point of sale device 240, and/or any one or more other portions of the system 200. For example, in some embodiments, the account application 237 is configured to send payment authorization information to, and/or receive transaction data from, the point of sale device 240. As another example, in some embodiments, the account application 237 is configured to create and/or send one or more notifications to the consumer 215 at the user interface system 220 that explain, for example, that the credit account 231 has incurred a liability, and/or that offsetting funds have been transferred from the deposit account 233 to the credit account 231. It will be further understood that, in some embodiments, the account application 237 includes computer-executable program code portions for instructing the processor 234 to perform any one or more of the functions of the account application 237 described and/or contemplated herein. In some embodiments, the account application 237 may include and/or use one or more network and/or system communication protocols.

In addition to the account application 237, the memory 236 also includes the account datastore 238. In some embodiments, the account datastore 238 includes information associated with one or more financial accounts (e.g., the credit account 231, the deposit account 233, one or more non-financial institution accounts (not shown), etc.), including, for example, account names, persons and/or entities associated with the financial accounts, addresses associated with the financial accounts, transaction data and/or transaction history associated with the financial accounts, whether one or more financial account are linked to one or more other financial accounts, and/or any other type and/or amount of information. In some embodiments, the account datastore 238 may also store any information relating to determining, recommending, and/or executing a payment strategy for offsetting liabilities and/or attributing rewards. In some embodiments, the account datastore 238 stores information associated with online and/or mobile banking.

It will be understood that the account datastore 238 may include any one or more storage devices, including, but not limited to, datastores, databases, and/or any of the other storage devices typically associated with a computer system. It will also be understood that the account datastore 238 may store information in any known way, such as, for example, by using one or more computer codes and/or languages, alphanumeric character strings, data sets, figures, tables, charts, links, documents, and/or the like. Further, in some embodiments, the account datastore 238 may include information associated with one or more applications, such as, for example, the account application 237. It will also be understood that, in some embodiments, the account datastore 238 provides a substantially real-time representation of the information stored therein, so that, for example, when the processor 234 accesses the account datastore 238, the information stored therein is current or substantially current.

It will be understood that the embodiment illustrated in FIG. 2 is exemplary and that other embodiments may vary. For example, in some embodiments, the deposit account 233 is actually a credit account, such that two credit accounts are linked to each other for offsetting liabilities. As another example, in some embodiments, the account management system 230 includes more, less, or different components, such as, for example, an account manager (e.g., financial institution employee) user interface.

As another example, in some embodiments, some or all of the portions of the system 200 may be combined into a single portion. Specifically, in some embodiments, the user interface system 220 and the account management system 230 are combined into a single user interface and account management system configured to perform all of the same functions of those separate portions as described and/or contemplated herein. Likewise, in some embodiments, some or all of the portions of the system 200 may be separated into two or more distinct portions. Specifically, in some embodiments, the account management system 230 may be separated into a financial account datastore system configured to store and/or manage transaction data, and a liability offsetting system configured to make liability determinations, transfer offsetting funds, and/or attribute rewards.

In addition, the various portions of the system 200 may be maintained for by the same or separate parties. For example, as previously mentioned, a single financial institution may maintain the credit account 231 and the deposit account 233, as well as the account management system 230. However, in other embodiments, the accounts and/or the account management system 230 may each be maintained by separate entities.

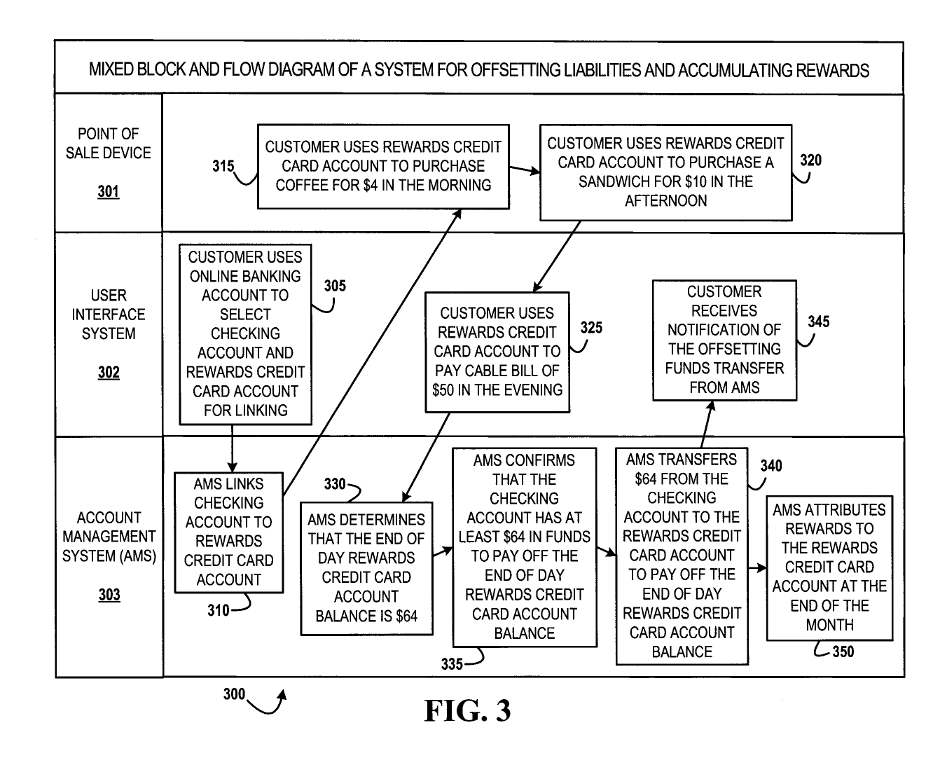

It will also be understood that the system 200 may include and/or implement any embodiment of the present invention described and/or contemplated herein. For example, in some embodiments, the system 200 is configured to implement any one or more of the embodiments of the process flow 100 described and/or contemplated herein in connection with FIG. 1, any one or more of the embodiments of the system 300 described and/or contemplated herein in connection with FIG. 3, any one or more of the embodiments of the process flow 400 described and/or contemplated herein in connection with FIG. 4, any one or more of the embodiments of the process flow 500 described and/or contemplated herein in connection with FIG. 5, and/or any one or more of the embodiments of the process flow 600 described and/or contemplated herein in connection with FIG. 6. Specifically, in some embodiments, the account application 237 is configured to cause the processor 234 to: (1) link the deposit account 233 to the credit account 231, as represented by the block 110 in FIG. 1; (2) determine that the credit account 231 has incurred a liability (e.g., in response to the credit account 231 actually incurring the liability via, e.g., the point of sale device 240), as represented by the block 120; (3) transfer funds from the deposit account 233 to the credit account 231 in an amount sufficient to offset the liability, as represented by the block 130; and (4) attribute rewards to the credit account 231 and/or the deposit account 233, as represented by the block 140.

Referring now to FIG. 3, a mixed block and flow diagram of a system 300 for executing a payment strategy for offsetting liabilities and attributing rewards is provided, in accordance with a specific embodiment of the present invention. As shown, the system 300 includes a point of sale device 301, a user interface system 302, and an account management system 303. It will be understood that the point of sale device 301 and the user interface system 302 are both operatively and selectively connected to the account management system 303 via a network (not shown). It will also be understood that the point of sale device 301 and the user interface system 302 are accessible to a bank customer (not shown), and that the bank customer has a checking account and a rewards credit card account that are maintained by the bank. It will further be understood that the bank provides the customer with access to an online banking account for managing and/or otherwise accessing the customer's bank and/or non-bank accounts.

As represented by the block 305, the customer first uses the user interface system 302 to access the online banking account in order to select the checking account and the rewards credit card account for linking Upon this selection, the account management system 303 is configured to automatically link the checking account to the rewards credit card account, as represented by the block 310. On the following morning, the customer visits a café and swipes the rewards credit card at the point of sale device 301 in order to purchase coffee for $4, as represented by the block 315. The customer returns to the café in the afternoon and uses the rewards credit card at the point of sale device 301 to purchase a sandwich for $10, as represented by the block 320. Later that evening, the customer uses the rewards credit card account to pay a $50 cable bill online via the user interface system 302, as represented by the block 325.

Thereafter, as represented by the block 330, the account management system 303 is configured to determine that the end of day balance for the rewards credit card account is $64. (It will be understood that the beginning of day rewards credit card account balance was zero.) Then, as represented by the block 335, the account management system 303 is configured to confirm that the checking account has at least $64 in funds to pay off the end of day rewards credit card balance. Next, the account management system 303 is configured to transfer the $64 from the checking account to the rewards credit card account in order to pay off the end of day rewards credit card balance, as represented by the block 340. Thereafter, the account management system 303 is configured to send notification (e.g., a digital receipt) of the offsetting funds transfer to the customer at the user interface system 302 (e.g., via the online banking account), as represented by the block 345. Later, as represented by the block 350, the account management system 303 is configured to attribute rewards to the rewards credit card account at the end of the month based at least partially on, for example, the total amount of purchases made with the credit card during that month.

It will be understood that, in accordance with some embodiments, the account management system 303 is configured to perform each of the steps 330-340 at the end of day, either simultaneously or one after another. In so doing, the account management system 303 ensures that the account balance for the rewards credit card account is zero at the end of the day. If the process illustrated in FIG. 3 is repeated every day, the rewards credit card account will maintain a zero average daily balance for the entire month (and the entire year and so on), which helps the customer avoid fees, late payments, lower credit scores, and/or the other negative effects associated with carrying a non-zero credit card balance. The process also mitigates or eliminates the hassles associated with making (and remembering to make) credit card payments, while enabling the customer to accumulate rewards as a result of using the rewards credit card account to make purchases.

It will be understood that one or more of the steps represented by the blocks 305-350 may be automatically triggered by one or more of the other steps represented by the blocks 305-350. It will also be understood that the embodiment illustrated in FIG. 3 and described herein represents a more-detailed embodiment of the present invention and that other embodiments of the present invention may vary. For example, other embodiments of the present invention may include more, fewer, and/or different types of systems and/or devices. In addition, it will be understood that the order, the number, and/or the content of the steps described in FIG. 3 may be different in other embodiments. It will also be understood that the system 300 may, where possible, include and/or implement any other embodiment of the present invention as described and/or contemplated herein. Likewise, any other embodiment of the present invention described and/or contemplated herein may, where possible, be configured to implement one or more of the steps 305-350.

With reference now to FIGS. 4-5, it will be understood that some embodiments of the present invention can be configured to determine and execute a payment strategy for offsetting liabilities and/or attributing rewards, such that the payment strategy is governed by one or more rules. For example, referring to FIG. 4, a system having the process flow 400 is configured to determine and execute a payment strategy based at least partially on one or more user-selected times. As another example, referring to FIG. 5, a system having the process flow 500 is configured to determine and execute a payment strategy based at least partially on one or more user-selected target amounts. It will be understood that, as discussed in more detail herein, additional or alternative rules may govern a payment strategy instead.

Referring now specifically to FIG. 4, as represented by the block 410, the system is configured to prompt a user (e.g., an online banking customer via an online and/or mobile banking account) to determine, input, create, define, select, etc. (collectively referred to herein as “select” for simplicity) a deposit account and a credit account to link. In addition, as represented by the block 420, the system is also configured to prompt the user to select one or more times for making both a liability determination and an offsetting funds transfer.

In accordance with some embodiments, a user-selected time refers to a specific time at which to make both a liability determination and an offsetting funds transfer, such as, for example, at 11:59 pm, 5:00 pm, the end of day, the end of week, the first and fifteenth of the month, 3:00 pm on the third of the month, etc. In some embodiments, a user-selected time refers to a period of time during which to make both a liability determination and an offsetting funds transfer, such as, for example, during one day, within one week, three weeks, one month, some time between 6:00 am and 5:00 pm, etc. In some embodiments, a user-selected time refers to a recurring time and/or a recurring period of time at/in/during which to make both a liability determination and an offsetting funds transfer, such as, for example, at the end of every day, at 11:59 PM every day, some time between 9:00 am and 5:00 pm every day, the first of every month, once every two weeks, after a three day period, during the second week of every month, during the fifteenth of every month, etc. It will be understood that, in other embodiments, the system having the process flow 400 is configured to prompt the user for one or more triggering events (e.g., any of the triggering events described and/or contemplated herein in connection with FIG. 1, etc.) for making both a liability determination and an offsetting funds transfer, instead of, or in addition to, one or more times. It will also be understood that in other embodiments, the system having the process flow 400 is configured to prompt the user for one or more times and/or triggering events for making a liability determination and for one or more different times and/or triggering events for making an offsetting funds transfer.

After prompting the user to make one or more selections, the system is configured to receive the user's selections, as represented by the block 430, and execute a payment strategy based at least partially on the user's selections, as represented by the block 440. Thereafter, the system is configured to implement the steps represented by the blocks 450-480. As represented by the block 450, the system is configured to determine, at a user-selected time (or during a user-selected period of time), whether the credit account has a balance. If yes, meaning the credit account does have a balance, then the system is configured to transfer funds from the deposit account to the credit account in an amount sufficient to pay off the entire balance, as represented by the block 470. Afterwards, the system is configured to wait until the next user-selected time, as represented by the block 480.

On the other hand, if the credit account does not have a balance, meaning the answer is no to the decision step represented by the block 450, then the system having the process flow 400 is configured to do nothing, as represented by the block 460. Thereafter, the system is configured to wait until the next user-selected time, as represented by the block 480. Thus, whether the answer to the decision step represented by the block 450 is yes or no, it will be understood that the system having the process flow 400 is configured to repeat the steps 450-480. Also, it will be understood that, in some embodiments, the user may select a “continuous time” setting, thereby configuring the system to continuously and repeatedly implement the steps 450-480.

Referring now to FIG. 5, in accordance with some embodiments of the present invention, the system having the process flow 400 may be additionally or alternatively configured to implement the process flow 500. As before, the system having the process flow 500 is configured to prompt a user to select a deposit account and a credit account to link, as represented by the block 510. In addition, as represented by the block 520, the system is also configured to prompt the user to select one or more target amounts for making an offsetting funds transfer. For example, in some embodiments, the user may select a $10 amount, a $500 amount, a $2,412 amount, and/or one or more other amounts as a target amount. As another example, in some embodiments, the user may select a range of amounts for the one or more target amounts, such as, for example, any amount less than or equal to $5,000, any amount above $1,500, any amount between $2 and $3,000, and so on. As another example, in some embodiments, the user may select “any positive amount” as the target amount, thereby configuring the system to treat any positive credit account balance as a target amount.

After the system receives the user's selections, as represented by the block 530, the system is configured to execute a payment strategy based at least partially on the user's selections, as represented by the block 540. Thereafter, the system is configured to implement the steps represented by the blocks 550-580. As represented by the block 550, the system is configured to determine whether the credit account has a balance greater than or equal to the user-selected target amount. It will be understood that, in some embodiments, the system is configured to continuously make this determination, but in other embodiments, the system is configured to make this determination at one or more predetermined times (e.g., at one or more user-selected times, which may include one or more recurring times), during one or more predetermined periods of time (e.g., sometime during the third week of every month), and/or upon or after one or more triggering events (e.g., every time the credit account incurs a liability).

If the answer is yes to the decision step represented by the block 550, meaning that the credit account does have a balance greater than or equal to the target amount, then the system is configured to transfer funds from the deposit account to the credit account in an amount sufficient to pay off the target amount, as represented by the block 570. (In some embodiments, the system is alternatively or additionally configured to pay off the entire balance of the credit account once the target amount is reached. Of course, in some cases, the target amount may be equal to the entire balance of the credit account.) Thereafter, the system is configured to wait until the next time the target amount is reached, as represented by the block 580.

On the other hand, if the credit account balance is not greater than or equal to the user-selected target amount, meaning that the answer is no to the decision step represented by the block 550, then the system having the process flow 500 is configured to do nothing, as represented by the block 560. Thereafter, the system is configured to wait until a target amount is reached, as represented by the block 580. Thus, whether the answer to the decision step represented by the block 550 is yes or no, it will be understood that the system having the process flow 500 is configured to repeat the steps 550-580.

It will be understood that one or more of the steps represented by the blocks 410-480 and/or 510-580 may be automatically triggered by one or more of the other steps represented by the blocks 410-480 and/or 510-580. It will also be understood that the number, order, and/or content of the steps represented by the blocks 410-480 and 510-580 are exemplary and may vary. For example, in some embodiments, the system having the process flow 400 and/or 500 may also be configured to attribute rewards to the deposit account and/or the credit account in any way described and/or contemplated herein (e.g., for transferring the offsetting funds, for having a credit account balance, etc.). It will also be understood that the system having the process flow 400 and/or 500 may, where possible, include and/or implement any other embodiment of the present invention as described and/or contemplated herein. Likewise, any other embodiment of the present invention described and/or contemplated herein may, where possible, be configured to implement one or more of the steps 410-480 and/or 510-580, as described in connection with FIGS. 4 and 5.

In addition to, or instead of, those rules described and/or contemplated herein in connection with FIGS. 4 and 5, it will be understood that one or more other rules may govern a payment strategy for offsetting funds and/or attributing rewards. For example, in some embodiments, a system having any one or more of the process flows described and/or contemplated herein (e.g., the process flow 100) is configured to execute a payment strategy that ensures that offsetting funds are transferred on or before the payment due date for the second (e.g., credit) account. As another example, in some embodiments, a system having the process flow 100 is configured to automatically execute the payment strategy unless the amount of funds in the first account falls below a predetermined (e.g., user-selected, system-determined, etc.) threshold (e.g., amount, percentage of an amount, etc.). In such embodiments, as another example of a rule, the system may be automatically configured to use funds from a third account (assuming that the third account has sufficient funds) to make the offsetting funds transfer.

As another example of a rule, in some embodiments, a system having the process flow 100 is configured to execute a payment strategy that ensures that an offsetting funds transfer never exceeds a predetermined (e.g., system-determined, user-selected, etc.) threshold (e.g., amount, percentage of an amount, etc.). For example, in some embodiments, the system is configured to never automatically transfer offsetting funds in an amount greater than or equal to $500. Instead, in such embodiments, the system prompts a user (e.g., via the user's online banking account) to authorize the funds transfer before the system makes the transfer. As another example of a rule, in some embodiments where the second account is a credit card account, a system having the process flow 100 is configured to automatically offset every liability incurred by the credit card account except those in which the credit card was not physically presented, i.e., “card not present” or “CNP” transactions. In such embodiments, the system may be configured to prompt the account holder for authorization before offsetting a CNP transaction.

As still another example, in some embodiments, a system having the process flow 100 is configured to determine and/or execute a payment strategy based at least partially on a predetermined geographic area (e.g., automatically pay off all transactions that occurred within ten miles of my home, never automatically pay off any transaction occurring outside of the United States, etc.). As a further example, in some embodiments, the payment strategy is based at least partially on a particular merchant and/or counterparty (e.g., automatically pay off all transactions involving ABC Bookstore, do not automatically pay off any transaction involving XYZ Co., etc.) and/or on a particular kind of good and/or service (e.g., automatically pay off all coffee transactions, automatically pay off all transactions involving a predetermined merchant category code, etc.). It will be understood that any one or more of the embodiments described and/or contemplated herein may be configured to determine and/or execute a payment strategy in accordance with any one or more of the rules described and/or contemplated herein.

Referring now to FIG. 6, a general process flow 600 of a system for determining and executing a payment strategy for offsetting liabilities based at least partially on a trend is provided, in accordance with an embodiment of the present invention. It will be understood that the general process flow 600 represents more-detailed embodiment of the general process flow 100 already described herein. Indeed, many of the steps of the general process flow 600 are similar, if not identical, to at least some of the steps of the general process flow 100. Because of these similarities, it will be understood that much of the description of the general process flow 100 also describes at least some of the steps of the general process flow 600 and that, for simplicity, most of that description will not be repeated herein. It will also be understood that a system having the process flow 100 can be additionally or alternatively configured to implement the process flow 600 and/or any other process flow described and/or contemplated herein. Likewise, any other embodiment of the present invention described and/or contemplated herein may, where possible, be configured to implement one or more of the steps 610-670.

Referring now specifically to FIG. 6, as represented by the block 610, the system having the process flow 600 is configured link a first account to a second account. As represented by the block 620, the system is configured to determine that the second account has incurred a liability. As represented by block 630, the system is also configured to receive information associated with a transaction history of the first account and/or information associated with a transaction history of the second account (sometimes referred to herein as “transaction history(ies)” for simplicity). As represented by the block 640, the system is then configured to determine a trend based at least partially on the transaction history of the first account and/or the transaction history of the second account. As represented by the block 650, the system is then configured to determine, based at least partially on the trend, a triggering event for making an offsetting funds transfer. As represented by the block 660, upon or after the triggering event, the system is configured to transfer funds from the first account to the second account in an amount sufficient to offset the liability. In some embodiments, as represented by the block 670, the system is also configured to attribute rewards to the first account and/or the second account.

It will be understood that, as used herein, the phrase “transaction history” typically refers to any of the information associated with any one or more individual transactions in which an account has been involved, such as, for example, the description of the goods/services involved in the transaction, the transaction date, the posting date, the type of transaction (e.g., purchase, deposit, credit, debit, draw, etc.), the transaction amount, the names of the merchants or counterparties involved in the transaction, the locations of the merchants or counterparties involved in the transaction, and/or any other transaction data. It will be understood that the transaction history contemplated herein includes the information typically provided to the account holder in a periodic (e.g., monthly) account statement and/or via an online and/or mobile banking account. Transaction history information may also include any information typically included in an itemized, standard purchase receipt.

It will also be understood that, as used herein, the term “trend” typically refers to one or more earning, spending, credit, debit, and/or other behaviors, tendencies, and/or patterns evidenced by the transaction history(ies). For example, in some embodiments, the system is configured to determine that a paycheck is regularly deposited into the first account on the first and fifteenth of every month. Based at least partially on this trend, the system may be configured to determine a triggering event for making the offsetting funds transfer as being two days after the next paycheck is deposited into the first account (i.e., the third or the seventeenth). As another example, in some embodiments, the system is configured to determine that the second account, which is a credit card account, is used to make a relatively large student loan payment on the last Monday of every month. Based at least partially on this trend, the system may be configured to schedule a triggering event for the offsetting funds transfer on the Friday before the last Monday of every month in order to avoid a situation where the credit card account does not have sufficient credit to make the student loan payment.

It will be understood that the system may determine a trend based on one or more transaction dates, transaction amounts, transaction orders, transaction descriptions, and/or any other information found in the transaction history of the first account and/or the transaction history of the second account. It will also be understood that a trend may be determined from only one transaction date, amount, description, etc. found in a transaction history. For example, in some embodiments, the system having the process flow 600 is configured to determine a triggering event for an offsetting funds transfer based solely on the date of an offsetting funds transfer made during a previous pay period.

It will also be understood that, in some embodiments, the step represented by the block 620 automatically triggers the system to implement, either immediately, nearly immediately, or sometime thereafter, the steps represented by the blocks 630-650. In other words, the system having the process flow 600 can be configured such that the triggering event determination occurs immediately, nearly immediately, or at some predetermined time after the liability determination. As such, in some embodiments, the system can be configured to determine a trend-based triggering event for making an offsetting funds transfer in real time or near real time after determining that the second account has incurred a liability.

It will also be understood that, in some embodiments, the system is configured to determine a trend based at least partially on something other than the transaction history(ies)—hence, the inclusion of the phrase “at least partially” herein. Similarly, in some embodiments, the system is configured to determine a triggering event for making the offsetting funds transfer based at least partially on something other than a trend. For example, in some embodiments, the system is configured to determine a triggering event based at least partially on one or more rules that govern the payment strategy, as discussed in detail in connection with FIGS. 4 and 5.

As another example, in some embodiments, the system having the process flow 600 is configured to prompt the user (e.g., the first and/or second account holder) to predict (e.g., input, determine, identify, define, etc.) a future earning and/or spending behavior, so that the system can determine a triggering event based at least partially on that user-predicted future behavior. This is helpful where the first account and/or the second account are new or relatively new accounts and therefore have little, if any, transaction history associated with those accounts. This is also helpful to check whether an account holder's future behavior will conform to his or her past behavior. For example, in some embodiments, the system is configured to communicate a trend previously determined by the system to the account holder, so that the holder can confirm or deny that the trend will hold true in the future. In some embodiments, the system prompts the user to predict any foreseeable changes to the holder's usual earning and/or spending behaviors (e.g., an expected raise, a new car payment, etc.), so that the system can determine a triggering event that accounts for these changes. In some embodiments, the system is configured to present to the holder how (e.g., via graphs, charts, text, etc.) the one or more user-predicted future behaviors affects or will affect a previously-determined triggering event, so that the holder can accept, modify, and/or reject the triggering event in light of this information.

It will be understood that one or more of the steps represented by the blocks 610-670 may be automatically triggered by one or more of the other steps represented by the blocks 610-670. It will also be understood that the number, order, and/or content of the steps represented by the blocks 610-670 are exemplary and may vary. For example, in some embodiments, the triggering event determined by the system and based at least partially on the trend may automatically trigger the liability determination in addition to, or instead of, the offsetting funds transfer.

As another example, in some embodiments, one or more of the steps 610-670 can be based at least partially on one or more user selections in response to one or more system prompts. Specifically, in some embodiments, the system is configured to prompt a user of the system to select a first account and a second account for linking In other embodiments, the system is additionally or alternatively configured to determine a trend, present the trend to a user (e.g., the first and/or second account holder, a financial institution employee, etc.) of the system, and prompt the user to select a triggering event based at least partially on that trend.

As another example, in some embodiments, the system having the process flow 600 is alternatively or additionally configured to provide, present, and/or otherwise communicate a triggering event recommendation to a user of the system (e.g., the first and/or second account holder), such that the user may accept, modify, or reject the triggering event before the system implements the triggering event into a payment strategy. It will be understood that the triggering event recommendation may take any form, include any amount and/or type of information, may be communicated in any way, and may be provided to any system, device, etc. and/or to any user of any system, device, etc. It will also be understood that the triggering event recommendation typically includes a summary of, and/or other information associated with, the triggering event determined by the system implementing the steps of the process flow 600.

In some embodiments, the triggering event recommendation includes functionality (e.g., one or more selectable buttons, fillable fields, etc.) that enables the user to accept, modify, and/or reject one or more portions of the triggering event recommendation. In some embodiments, the triggering event recommendation includes information associated with one or more other triggering events in addition to, or instead of, the triggering event determined by the steps of the process flow 600. These one or more other triggering events may correspond to one or more triggering events previously determined by the system having the process flow 600 (e.g., a triggering event previously determined for and/or selected by the user, a triggering event determined for another, similarly-situated user, etc.), one or more “default” triggering events (e.g., make an offsetting funds transfer two days after making a liability determination, etc.), and/or the like. In some embodiments, the triggering event recommendation includes information associated with several triggering events, thereby increasing the number of triggering events from which the user may select.

In some embodiments, the system having the process flow 600 is configured to communicate the triggering event recommendation to the first and second account holder via an online and/or mobile banking account. In some embodiments, the triggering event recommendation may include or take the form of an e-mail message, instant message, pop-up, pop-under, video, mobile alert, and/or some other notification accessible via an online and/or mobile banking account.

In other embodiments, the system having the process flow 600 is configured to provide the triggering event recommendation to a financial institution employee (e.g., customer service representative, bank teller, etc.), so that the employee may then communicate the triggering event recommendation to the account holder via, for example, in-person communication, telephone call, e-mail message, mobile alert, and/or some via some other kind of notification and/or communication. For example, in some embodiments, the system having the process flow 600 is configured to provide the triggering event recommendation to a customer service representative at that representative's computer, terminal, etc. when that representative accesses the account holder's profile during a customer service call with the account holder.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for transferring offsetting funds from a first account to a second account, the method comprising:
determining that the second account comprises a liability; and
transferring funds from the first account to the second account in an amount sufficient to offset the liability,
wherein the determining step automatically triggers the transferring step.

2. The method of claim 1, further comprising attributing rewards to the first account or the second account based at least partially on the transferring step.

3. The method of claim 1, further comprising attributing rewards to the second account based at least partially on the second account incurring the liability.

4. The method of claim 1, further comprising determining that the first account comprises funds sufficient to offset the liability.

5. The method of claim 1, wherein the determining step further comprises determining, at end of day, that the second account comprises the liability.

6. The method of claim 1, wherein the first account comprises a deposit account and the second account comprises a credit account.

7. The method of claim 1, wherein the first account is maintained by a first financial institution and the second account is maintained by a second financial institution.

8. The method of claim 1, wherein the first account comprises two or more accounts.

9. The method of claim 1, wherein the transferring step occurs immediately or nearly immediately after the determining step.

10. The method of claim 1, wherein the second account incurring the liability automatically triggers the determining step.

11. The method of claim 10, wherein the determining step occurs immediately or nearly immediately after the second account incurs the liability.

12. The method of claim 1, wherein the transferring step and the determining step are both implemented on the same day.

13. The method of claim 1, wherein a user-selected triggering event automatically triggers the determining step.

14. The method of claim 13, wherein the user-selected triggering event comprises a user-selected time.

15. The method of claim 1, wherein the liability comprises an amount greater than or equal to a user-selected target amount.

16. The method of claim 1, further comprising:
determining a trend based at least partially on a transaction history of the first account or a transaction history of the second account; and
determining a triggering event based at least partially on the trend, wherein the transferring step occurs immediately or nearly immediately after an occurrence of the triggering event.

17. The method of claim 16, further comprising:
communicating a triggering event recommendation to a user, wherein the triggering event recommendation comprises information associated with the triggering event, and wherein the triggering event recommendation comprises functionality configured to enable the user to accept, modify, or reject one or more portions of the triggering event recommendation.

18. The method of claim 1, further comprising determining a triggering event based at least partially on a user-predicted future behavior, wherein the transferring step occurs immediately or nearly immediately after an occurrence of the triggering event.

19. A system for transferring offsetting funds from a first account to a second account, the system comprising:
a processor configured to:
determine that the second account comprises a liability; and
transfer funds from the first account to the second account in an amount sufficient to offset the liability, wherein the processor determining that the second account comprises the liability automatically triggers the processor to transfer the funds from the first account to the second account.

20. The system of claim 19, wherein the processor is further configured to attribute rewards to the first account or the second account based at least partially on the transfer of funds from the first account to the second account.

21. The system of claim 19, wherein the processor is further configured to attribute rewards to the second account based at least partially on the second account incurring the liability.

22. The system of claim 19, wherein the processor is further configured to determine that the first account comprises funds sufficient to offset the liability.

23. The system of claim 19, wherein the processor is configured to transfer the funds immediately or nearly immediately after determining that the second account comprises the liability.

24. The system of claim 19, wherein the second account incurring the liability automatically triggers the processor to determine that the second account comprises the liability.

25. The system of claim 24, wherein the processor is configured to determine that the second account comprises the liability immediately or nearly immediately after the second account incurs the liability.

26. The system of claim 19, wherein a user-selected triggering event automatically triggers the processor to determine that the second account comprises the liability.

27. The system of claim 26, wherein the user-selected triggering event comprises a user-selected time.

28. The system of claim 19, wherein the liability comprises an amount greater than or equal to a user-selected target amount.

29. The system of claim 19, wherein the processor is further configured to:
determine a trend based at least partially on a transaction history of the first account or a transaction history of the second account; and
determine a triggering event based at least partially on the trend, wherein the processor is configured to transfer the funds from the first account to the second account immediately or nearly immediately after an occurrence of the triggering event.

30. The system of claim 29, wherein the processor is further configured to:
communicate a triggering event recommendation to a user, wherein the triggering event recommendation comprises information associated with the triggering event, and wherein the triggering event recommendation comprises functionality configured to enable the user to accept, modify, or reject one or more portions of the triggering event recommendation.

31. The system of claim 19, wherein the processor is further configured to determine a triggering event based at least partially on a user-predicted future behavior, and wherein the processor is configured to transfer the funds from the first account to the second account immediately or nearly immediately after an occurrence of the triggering event.

32. A computer program product for transferring offsetting funds from a first account to a second account, the computer program product comprising a computer-readable medium having computer-executable program code portions stored therein, wherein the computer-executable program code portions comprise:
a first program code portion configured to determine that the second account comprises a liability; and
a second program code portion configured to transfer funds from the first account to the second account in an amount sufficient to offset the liability,
wherein execution of the first program code portion automatically triggers execution of the second program code portion.

33. The computer program product of claim 32, further comprising a third program code portion configured to attribute rewards to the first account or the second account based at least partially on an offsetting transfer of funds from the first account to the second account.

34. The computer program product of claim 32, further comprising a third program code portion configured to attribute rewards to the second account based at least partially on the second account incurring the liability.

35. The computer program product of claim 32, further comprising a third program code portion configured to determine that the first account comprises funds sufficient to offset the liability.

36. The computer program product of claim 32, wherein the second program code portion is configured to be executed immediately or nearly immediately after execution of the first program code portion.

37. The computer program product of claim 32, wherein the second account incurring the liability automatically triggers execution of the first program code portion.

38. The computer program product of claim 37, wherein the first program code portion is configured to be executed immediately or nearly immediately after the second account incurs the liability.

39. The computer program product of claim 32, wherein a user-selected triggering event automatically triggers execution of the first program code portion.

40. The computer program product of claim 39, wherein the user-selected triggering event comprises a user-selected time.

41. The computer program product of claim 32, wherein the liability comprises an amount greater than or equal to a user-selected target amount.

42. The computer program product of claim 32, further comprising:
a third program code portion configured to determine a trend based at least partially on a transaction history of the first account or a transaction history of the second account; and
a fourth program code portion configured to determine a triggering event based at least partially on the trend, wherein the second program code portion is configured to be executed immediately or nearly immediately after an occurrence of the triggering event.

43. The computer program product of claim 42, further comprising:
a fifth program code portion configured to communicate a triggering event recommendation to a user, wherein the triggering event recommendation comprises information associated with the triggering event, and wherein the triggering event recommendation comprises functionality configured to enable the user to accept, modify, or reject one or more portions of the triggering event recommendation.

44. The computer program product of claim 32, further comprising a third program code portion configured to determine a triggering event based at least partially on a user-predicted future behavior, wherein the second program code portion is configured to be executed immediately or nearly immediately after an occurrence of the triggering event.

45. A system for transferring offsetting funds from a first account to a second account, the system comprising:
a processor configured to:
determine that the second account comprises a liability;
determine a trend based at least partially on a transaction history of the first account or a transaction history of the second account;
determine a triggering event based at least partially on the trend; and
transfer funds from the first account to the second account in an amount sufficient to offset the liability,
wherein an occurrence of the triggering event automatically triggers the processor to transfer the funds from the first account to the second account.

46. The system of claim 45, wherein the processor is further configured to transfer the funds from the first account to the second account immediately or nearly immediately after an occurrence of the triggering event.

47. The system of claim 45, wherein the processor determining that the second account comprises the liability automatically triggers the processor to determine the trend.

48. The system of claim 45, wherein the processor is further configured to attribute rewards to the first account or the second account based at least partially on the transfer of funds from the first account to the second account.

49. The system of claim 45, wherein the processor is further configured to attribute rewards to the second account based at least partially on the second account incurring the liability.

50. The system of claim 45, wherein the processor is further configured to determine that the first account comprises funds sufficient to offset the liability.

51. The system of claim 45, wherein the second account incurring the liability automatically triggers the processor to determine that the second account comprises the liability.

52. The system of claim 51, wherein the processor is configured to determine that the second account comprises the liability immediately or nearly immediately after the second account incurs the liability.

53. The system of claim 45, wherein a user-selected triggering event automatically triggers the processor to determine that the second account comprises the liability.

54. The system of claim 53, wherein the user-selected triggering event comprises a user-selected time.

55. The system of claim 45, wherein the liability comprises an amount greater than or equal to a user-selected target amount.

56. The system of claim 45, wherein the processor is further configured to:
communicate a triggering event recommendation to a user, wherein the triggering event recommendation comprises information associated with the triggering event, and wherein the triggering event recommendation comprises functionality configured to enable the user to accept, modify, or reject one or more portions of the triggering event recommendation.

57. The system of claim 45, wherein the processor is further configured to determine the triggering event based at least partially on a user-predicted future behavior.
